(19) United States
(12) Patent Application Publication
(10) Pub. No.: US 2026/0194111 A1
(43) Pub. Date: Jul. 9, 2026

(54) METHOD FOR PRODUCING A COUNTER TRACK JOINT

(71) Applicant: GKN Driveline International GmbH, Lohmar (DE)

(72) Inventors: Stephan Maucher, Lohmar (DE); Ida Benner, Lohmar (DE); Thomas Weckerling, Lohmar (DE); Rolf Cremerius, Lohmar (DE); Hans-Jürgen Post, Lohmar (DE); Anna Gremmelmaier, Lohmar (DE)

(21) Appl. No.: 18/869,353

(22) PCT Filed: Jun. 10, 2022
(86) PCT No.: PCT/EP2022/065885

§ 371 Date: Nov. 26, 2024

(51) Int. Cl. F16D 3/2233

(52) U.S. Cl. CPC F16D 3/2233; F16D 2250/0053; F16D 2300/10; F16D 2300/12

(57) ABSTRACT

The invention relates to a method for producing a counter track joint, comprising: producing a first joint part (12) with first and second ball tracks (22A, 22B) that are soft-finished and hardened, i.e. remain unmachined after hardening; determining a first working PCD value (WPCD12) from a first curvature of the first ball tracks (22A) and a second curvature of the second ball tracks (22B); classifying the first joint part (12) to a size class of at least two different size classes (C12a, C12b, C12c); producing a second joint part (13) with first and second ball tracks (23A, 23B); assigning the second joint part (13) to the first joint part (12), with a difference between WPCD12 and WPCD13 being greater than 20 and smaller than 30 micrometers; producing a ball cage (15) and balls (14A, 148); mounting the joint parts; wherein in the mounted condition, a first axial play (So) of the ball cage (15) to the first joint part (12) differs from a second axial play (Si) of the ball cage (15) to the second joint part (13).

The invention relates to a method of producing a constant velocity joint in the form of a counter track joint.

From WO 2007 028 435 A1, a counter track joint is known comprising an outer joint part with first and second outer ball tracks, an inner joint part with first and second inner ball tracks. The first outer and inner ball tracks form first pairs of tracks which widen in a first axial direction. The second outer and inner ball tracks form second pairs of tracks which widen in a second axial direction. Balls are held in a ball cage and guided in the pairs of tracks. Axial clearances are provided between the outer joint part and the ball cage on the one hand, and the ball cage and the inner joint on the other, which permit a relative axial displacement between the inner and outer joint part. After forming with the necessary excess dimension needed for machining being provided, the inner spherical guiding face of the outer joint part is soft-turned and subsequently hardened, whereas the ball tracks are hardened and ground after the forming operation.

From DE 100 60 120 A1, a counter track joint is known with the outer joint part and the inner joint part being axially displaceable relative to each other. From WO 2006 048 031 A1, another counter track joint is known with specific geometric values.

From JP H11 13780 A, a universal joint is known with an outer and inner joint member. The inner joint member is forged from raw material and heat treated, and regarding the form of the ball grooves left in the state of forging. The dimension of the ball grooves is measured to divide the inner joint member into three groups according to the dimension. The outer joint member is forged, heat treated and finish worked. The ball grooves of the outer joint member are worked by grinding finishing after heat treatment.

From JP 2005 337 290 A, a drive shalt for an all-terrain vehicle is known including a double offset joint on the inboard side and an undercut-free universal joint on the outboard side. The track clearance of the universal joint is in the range of 20 to 200 micrometers (μm). The PCD of the track groove of the outer ring and the inner ring is measured and ranked according to a width of about 20 μm. From the combination of multiple outer rings and the inner ring, the track clearance is about 20 to 60 μm for the universal joint and 20 μm for the double offset joint. A matching operation is performed to determine the outer ring and inner ring to be paired so that the distance is about 80 μm. The inner and outer ring track grooves have a cold forging finish.

From DE 44 09 706 A1, a method and a device in which both manufacturing tolerances in the radial depth of the ball tracks and their pitch tolerances can be detected. The joint part to be classified is received in an axially defined position relative to its longitudinal axis, however so as to be freely movable relative to a gauge ring in a plane perpendicular to said axis. Measuring balls held in openings of the gauge ring corresponding to the number of ball tracks are brought into contact with the respective ball tracks by axial displacement of a measuring cone relative to the gauge ring. The axial position of the measuring cone thereby assumed relative to the gauge ring is used as a reference variable for the classification of the joint parts. Thus, a specific group of inner joint parts can be assigned to a specific group of outer joint parts.

From EP 2 345 823 A1 a fixed type constant velocity joint is known, including: an outer joint member with an inner spherical surface and a plurality of track grooves, an inner joint member with an outer spherical surface and a plurality of track grooves, a plurality of balls interposed in the track grooves of the outer and inner joint member, and a cage interposed between the inner spherical surface and the outer spherical surface. At least one of the plurality of track grooves is formed by cold-forging finishing. The outer joint member, the inner joint member, the balls and the cage are assembled to each other based on matching in which the balls and the cage each having a rank corresponding to a measured value of a PCD of the outer joint member.

From DE 10 2010 051 353 A1, a constant velocity joint is known wherein the inner circumferential surface of the outer joint part and/or the outer circumferential surface of the inner joint part are hardened but are not further machined after hardening.

It is an object of the present invention to propose a method for producing a constant velocity joint in the form of a counter track joint which is cost-effective, has a high efficiency during operation and a long service life.

To solve the object, a constant velocity joint in the form of a counter track joint according to claim 1 is proposed. Further optional embodiments are proposed in the dependent claims 2 to 15.

According to the invention, the first and second ball tracks of the first joint part are soft-finished and hardened, i.e. they remain mechanically unmachined after hardening. The first and second ball tracks of the second joint part are soft-worked, hardened, and can optionally be hard-machined after hardening. Thus, the counter track joint has an advantage in that it can be produced cost-effectively due to the ball tracks of the first joint part being finish machined before hardening. According to a preferred first option, the first and second ball tracks of the second joint part can be hard-machined. In this case, a particularly good guiding function for the balls and thus high efficiency can be achieved, due to the hardened and subsequently hard-finished ball tracks of the second joint part in which the balls run. Thus, a good balance between cost-effective production and a high efficiency during operation with a long service life can be achieved. According to a second option, the first and second ball tracks of the second joint part may be produced in the same manner as the tracks of the first joint part, i.e. they can be soft-finished and hardened, i.e. they can remain mechanically unmachined after hardening. In this case, the joint can be produced in a very cost-effective manner due to the omission of any hard-machining.

The first option, with one joint parts being soft-finished and the other one of the joint parts being hard-finished can be generally implemented in two embodiments, which arise from the assignment of the ball tracks being finish-machined before or after hardening. In a first embodiment, the ball tracks soft-finished before hardening can be assigned to the outer joint part, while the hardened and subsequently hard-finished ball tracks are assigned to the inner joint part. According to a reverse second embodiment, the ball tracks soft-finished before hardening may be associated with the inner joint part, while the hardened and subsequently hard-finished ball tracks are associated with the outer joint part.

In the context of the present disclosure, soft-finished particularly includes that the desired ball track geometry is generated solely by soft machining, that is, the track geometry is effected and completed prior to hardening. After hardening, no further geometry-changing machining of the ball tracks is provided, in particular no cutting machining. The ball tracks can be soft-finished by forming, for example by forging, hot forming, cold forming, stamping and/or hammering. Alternatively or in addition, the ball tracks may be soft-machined, at least also in intermediate steps, for example by milling, turning and/or grinding operations.

Further, in the context of the present disclosure, hardened and hard-machined means in particular that the respective ball tracks are prefabricated with appropriate oversize before hardening and are finish-machined to the desired final geometry after hardening. The prefabrication can be carried out by machining processes, such as turning or milling, and/or by non-cutting manufacturing processes, such as forming, forging or stamping. The finish machining can be carried out in particular by chip forming, for example by grinding and/or turning. In finishing, the oversize material of the respective surfaces provided in the intermediate product is removed after hardening, which may be a few tenths of a millimeter, for example.

The ball tracks that are hard-machined by grinding and/or turning, for example, can have a lower surface roughness than the soft-finished ball tracks, which are unmachined after hardening. The latter can optionally have a microstructure that is created by shot peening before or after hardening.

According to the proposed method, a working pitch circle diameter (WPCD) of the first joint part is determined. The first WPCD can be determined as a function of the curvature of the first ball tracks and the curvature of the second ball tracks of the first joint part. For example, the first WPCD can be determined based on the smallest circle around one or more track curvatures (A) of the first ball tracks and one or more track curvatures (B) of the second ball tracks of the first joint part. Measuring and using the first WPCD is advantageous in that only one value needs to be determined for grading purposes of the first joint part. The first WPCD lays within a first overall PCD tolerance range (ΔWPCD) which can be, for example, between 30 and 300 micrometers. The first overall PCD tolerance range (ΔWPCD) can be divided into at least two different size classes (C12a, C12b, C12c), wherein the first joint part can be classified into one of said different size classes depending on the first WPCD determined.

It is proposed that the first and second ball tracks are hard-machined such that a working pitch circle diameter (WPCD) of the second joint part is within a second overall PCD tolerance range (ΔWPCD) that is greater than 40 micrometers, for example between 40 and 300 micrometers. The second WPCD is determined as a function of a curvature of the first ball tracks and a curvature of the second ball tracks of the second joint part. For example, the second WPCD may be determined to be the smallest intersection of one or more track curvatures (A′) of the first ball tracks and one or more track curvatures (B′) of the second ball tracks of the second joint part.

According to the proposed method, the second joint part is assigned to the first joint part depending on the size class (C12a, C12b, C12c) to which the first joint part has been classified. In particular, the first and second joint parts are selected, i.e. matched such that the difference between the PCD of the first joint part and the PCD of the second joint part is greater than 20 and smaller than 80 micrometers.

An advantage of the proposed method is that selecting and matching of a first joint part and a second joint part to each other can be done solely on the basis of the determined WPCD of the first joint part and the WPCD of the second joint part. No further faces or other values, such as the inner face of the outer joint part, the outer face of the inner joint part or any offset of the outer or inner joint part, need to be measured, classified or matched. Thus, the production of the counter track joint is easy and cost-effective.

The balls can be produced with a production tolerance of less than four micrometers, i.e. ±2 micrometers, with respect to a nominal ball diameter. Thus, the balls are produced with relatively small manufacturing tolerance, i.e. with high manufacturing accuracy. In this manner, any one of the balls produced with this manufacturing tolerance can be used, with the first joint part and second joint part having been paired to each other, to complete the counter track joint. No matching or grading of the balls to any specific first joint part or second joint part is necessary which makes production of the joint easy and cost-effective.

Each one of the at least two first size classes (C12a, C12b, C12c) defined for classifying the first joint part can cover a first WPCD value range (R12a, R12b, R12c) of at least 10 and at most 45 micrometers.

The second joint part can be selected such that the second WPCD deviates by 5 to 50 micrometers from an edge value of the first WPCD value range of a respective first size class of the first joint part. If the first joint part is an outer joint part, then the nominal PCD for the second joint part, i.e. inner joint part, is smaller than the smallest value of the respective first PCD value range. Vice versa, it first joint part is inner joint part, then the nominal PCD for the second joint part, i.e. outer joint part, is bigger than biggest value of the respective second WPCD value range.

The first WPCD of the first joint part may be obtained from intersections of the first curvatures of the first ball tracks and the second curvatures of the second ball tracks of the first joint part. The second WPCD of the second joint part may be obtained from intersections of the first curvatures of the first ball tracks and the second curvatures of the second ball tracks of the second joint part.

The first WPCD of the first joint part can be determined in a system plane (ES) where the PCD of one or more of the first ball tracks equals the PCD of one or more of the second ball tracks of the first joint part. In particular, the first WPCD can be determined as smallest roundness or circle around the combined first and second track curvatures (A, B). The system plane (ES) is arranged axially between an offset plane (EA) of the first ball tracks and an offset plane (EB) of the second ball tracks the first joint part, in particular not centered therebetween. The opening sided offset plane (EA) can be defined by a maximum curvature portion of the first ball tracks having the greatest radial distance from the first longitudinal axis (L12). The attachment sided offset plane (EB) can be defined by the maximum curvature portion of the second ball tracks having the greatest radial distance from the longitudinal axis (L12).

According to an embodiment, the first joint part can be assigned to a first size class (C12a) when the first WPCD value is within a first predetermined PCD range (R12a), or to a second size class (C12b) when the first WPCD value is within a second predetermined WPCD range (R12b), or to a third size class (C12c) when the first WPCD value is within a third predetermined WPCD range (R12c).

The first joint part, the second joint part and the ball cage can be produced such that, in the assembled and aligned condition of the counter track joint, the first axial play (So) between the ball cage and the first joint part differs from the second axial play (Si) between the ball cage and the second joint part by more than 25 micrometers. The outer cage surface and the inner surface of the outer joint part on the one hand, and the inner cage surface and the outer surface of the inner joint part on the other hand, can be produced such that, in the assembled and aligned condition of the counter track joint, an outer radial clearance between the ball cage and the outer joint part, and an inner radial clearance between the ball cage and the inner joint part are different in size, and/or an outer axial clearance (So) between the ball cage and the outer joint part and an inner axial clearance (Si) between the ball cage and the inner joint part are different in size. For example, one of the first axial play and the second axial play (So, Si) can be greater than 50 micrometers and the other one of first axial play and the second axial play (Si, So) can be greater than 75 micrometers. If the outer joint part, respectively the outer ball tracks are soft-finished before hardening, then the outer radial clearance is preferably larger than the inner radial clearance. Vice versa, if the inner joint part, respectively the inner ball tracks, are soft-finished before hardening, the outer radial clearance is preferably smaller than the inner radial clearance.

According to an embodiment, the first joint part can be produced in form of an outer joint part, and the second joint part can be produced in form of an inner joint part. In this case, the first ball tracks, second ball tracks and circumferential surface of the outer joint part can be soft-finished, in particular by a forming process and/or forging. Then, the first and second outer ball tracks of the outer joint part can be hardened. The first ball tracks, second ball tracks and circumferential surface of the inner joint part can be soft pre-machined, then hardened, and then hard finish-machined, in particular by a chip forming process, such as turning, milling and/or grinding.

According to an embodiment, the first outer ball tracks can be formed so as to have a first outer undercut on the opening side, and the second outer ball tracks can be formed so as to have a second outer undercut on the opening side, wherein the first outer undercut can be smaller than the second outer undercut.

At least one of the outer cage surface and the inner cage surface can be soft-finished, in particular by a forming process, and then hardened.

The outer joint part and the inner joint part are produced such that the inner joint part, during operation of the counter track joint, is angularly movable relative to the outer joint part by an articulation angle (β) of in particular more than 20° and up to 30°, This articulation angle (β) can also be referred to as working or operating articulation angle. It can be defined as articulation angle where all of the balls when moving in the respective pairs of tracks towards the opening side are still held in the pairs of tracks. The ratio of the working PCD (WPCD) of the outer joint part to the largest diameter (d) of an insertion opening of the inner joint part can be smaller than 2.05, for example (WPCD/d<2.05).

For mounting the balls, the inner joint part can be rotated relative to the outer joint part such that the first inner ball tracks are opposite the first outer ball tracks and form first pairs of tracks which widen towards the opening side of the outer joint part, and the second inner ball tracks are opposite the second outer ball tracks and form second pairs of tracks which widen towards the connecting side of the outer joint part. Then, the balls can be inserted into said cage windows with said inner joint part and outer joint part deflected relative to each other, with said first and second pairs of tracks each receiving one of said torque transmitting balls. The balls are held by the ball cage on a joint center plane (EM) with the longitudinal axes of the inner and outer joint part aligned coaxially. A partial number of webs of the inner joint part can be produced with flattenings on both sides, so that threading into a cage window of the ball cage for assembly is possible. Additionally or as an alternative, at least a partial number of the second outer ball tracks of the outer joint part can be produced on the connecting side with a pocket which is radially recessed with respect to a functional track portion and into which an associated ball can move radially when the constant velocity joint is articulated.

The first and second outer ball tracks are preferably designed such that, viewed in cross section, a two-point contact is formed in each case with the associated ball. Alternatively or additionally, the first and the second inner ball tracks can also be designed such that, viewed in cross section, a two-point contact is formed in each case with the associated torque-transmitting ball. A two-point contact can be created, for example, by a track shape that is gothic or elliptical in a cross sectional view through the track. A two-point contact, respectively two-point path is advantageous for measuring the ball tracks in a self-centering manner. However, a circular track in cross section can also be used.

Preferred embodiments are explained below with reference to the drawing figures. Herein:

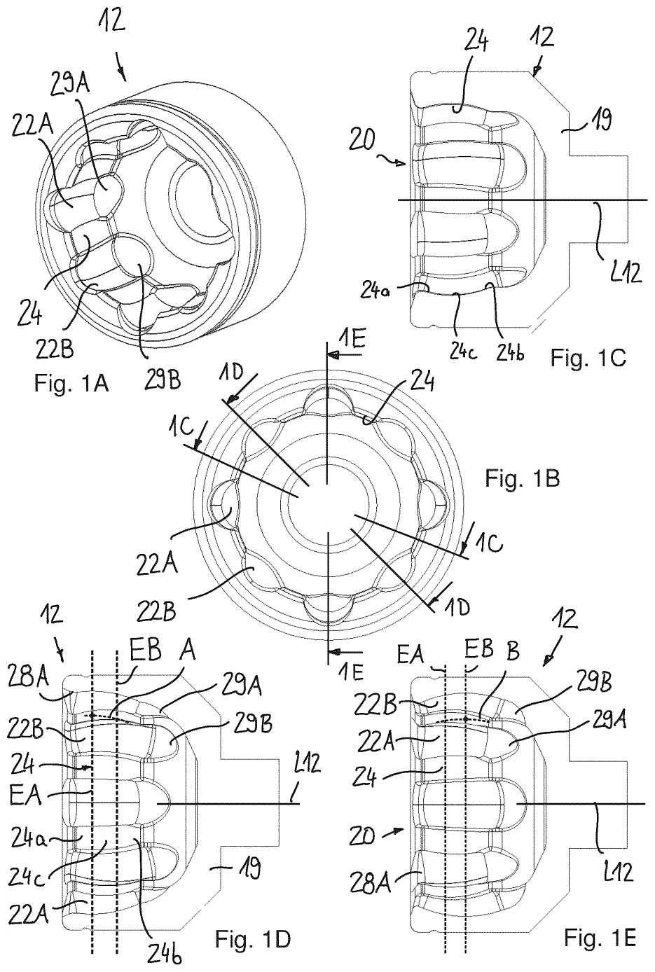

FIG. 1A shows a three-dimensional view of a first joint part in the form of an outer joint part for a constant velocity joint produced with the method according to the invention;

FIG. 1B shows the first joint part of FIG. 1A in an axial view;

FIG. 1C shows the first joint part in a longitudinal section through a pair of webs along section line 1C-1C of FIG. 1B;

FIG. 1D shows the first joint part in a longitudinal section through outer first ball tracks along section line 1D-1D of FIG. 1B;

FIG. 1E shows the first joint part in a longitudinal section through outer second ball tracks along section line 1E-1E of FIG. 1B;

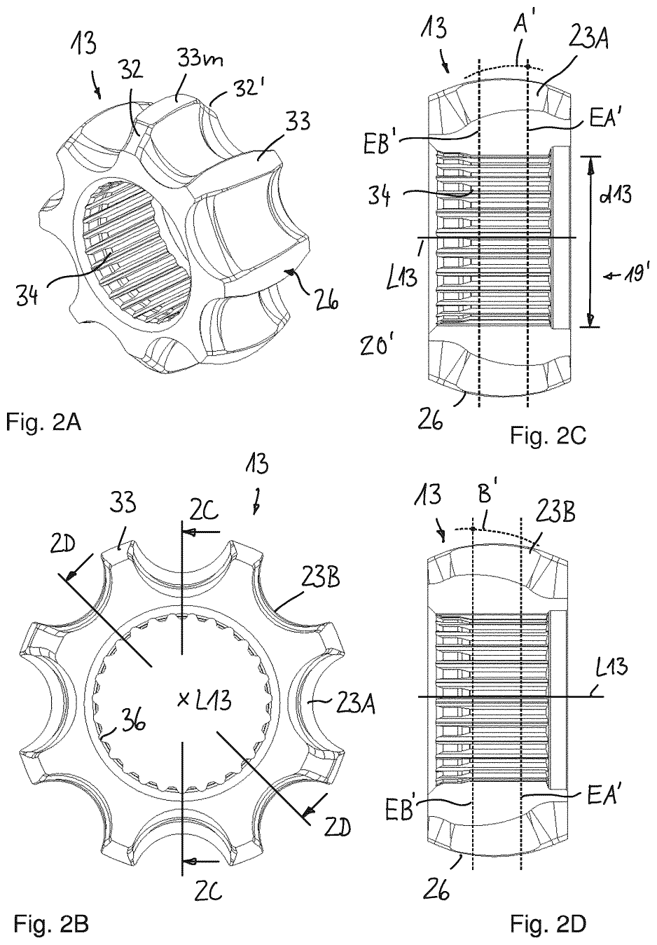

FIG. 2A shows a second joint part in the form of an inner joint part for a constant velocity joint produced according to the invention;

FIG. 2B shows the second joint part of FIG. 2A in an axial view;

FIG. 2C shows the second joint part in a longitudinal section through inner first ball tracks along section line 2C-2C of FIG. 2B;

FIG. 2D shows the second joint part in a longitudinal section through inner second ball tracks along section line 2D-2D of FIG. 2B;

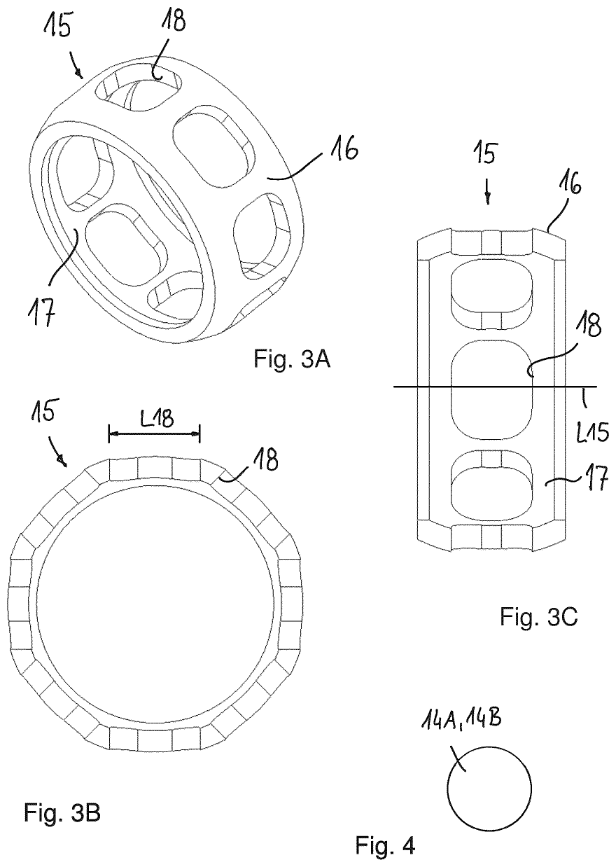

FIG. 3A shows a ball cage for a constant velocity joint produced according to the invention in a three-dimensional view;

FIG. 3B shows the ball cage of FIG. 3A in a cross section through the cage windows;

FIG. 3C shows the ball cage of FIG. 3A in a longitudinal section;

FIG. 4 shows a ball for a constant velocity joint produced with the method according to the invention;

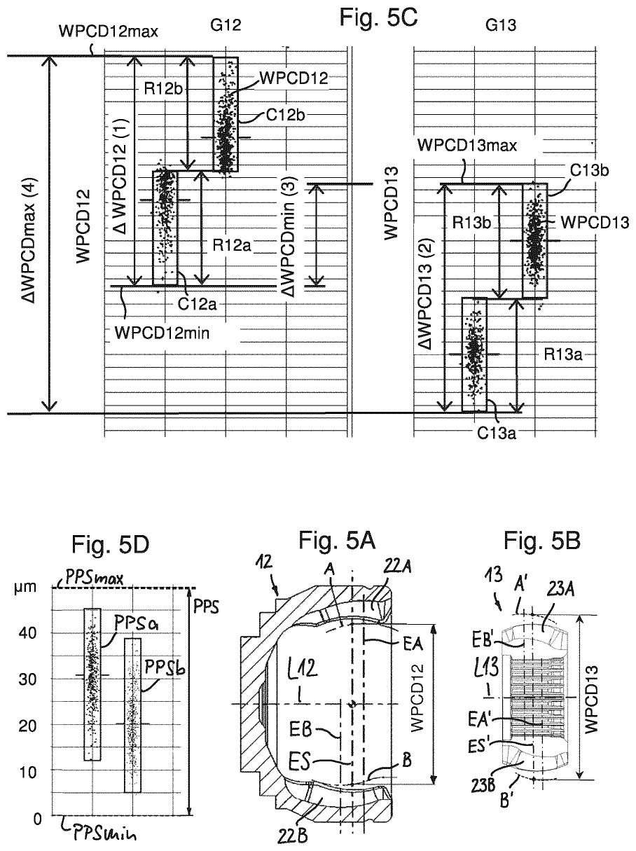

FIG. 5A shows an outer joint part in a longitudinal section through a first ball track in the upper half and a second ball track in the lower half;

FIG. 5B shows an outer joint part in a longitudinal section through a first ball track in the upper half and a second ball track in the lower half;

FIG. 5C shows a graphical representation of measurement results of batches of first and second joint parts assigned to a respective tolerance group;

FIG. 5D shows a graphical representation of pitch path separations PPS of pairs of a first inner and outer ball track and pairs of a second inner and outer ball track of inner and outer joint parts, which are assigned to each other according to their tolerance groups shown in FIG. 5C;

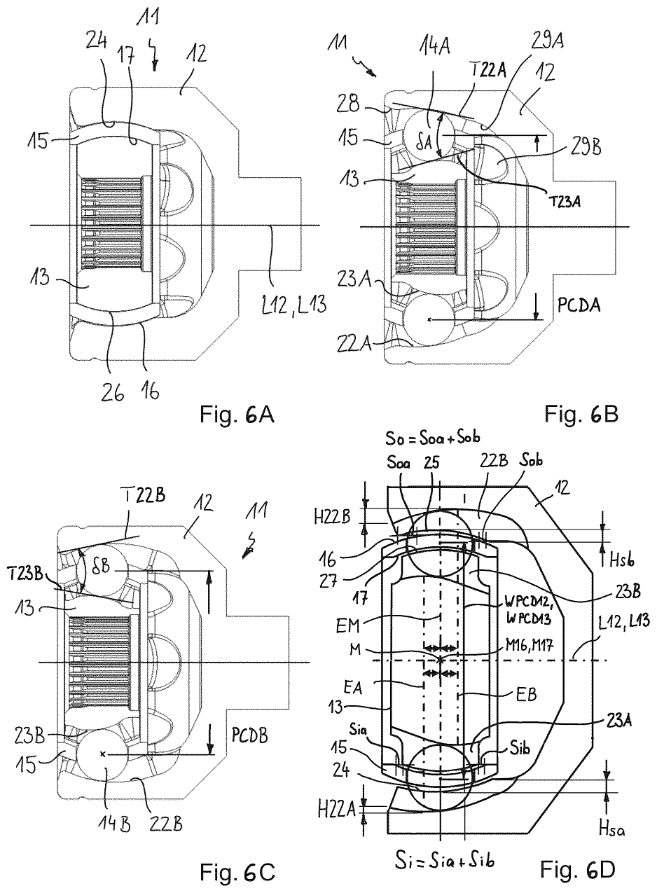

FIG. 6A shows a counter track joint produced with the method according to the invention in a longitudinal section through web portions:

FIG. 6B shows the counter track joint of FIG. 6A in a longitudinal section through first pairs of tracks opening in a first direction;

FIG. 6C shows the counter track joint of FIG. 6A in a longitudinal section through second pairs of tracks opening in a second direction;

FIG. 6D shows the counter track joint of FIG. 6A in a simplified representation with a first pair of tracks in the lower half, and a second pair of tracks in the upper half;

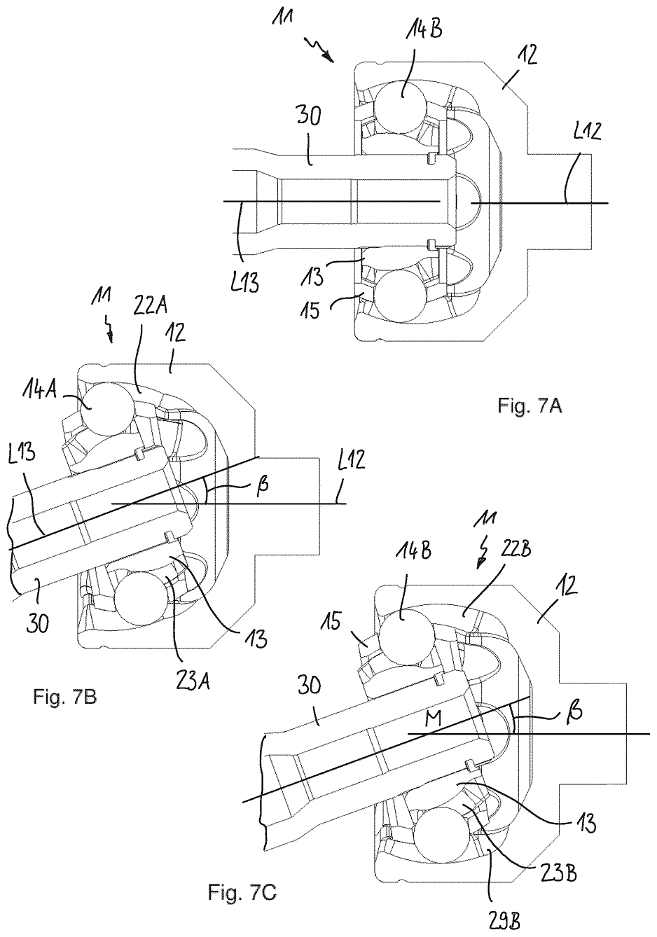

FIG. 7A shows the counter track joint of FIGS. 6A-6D with a shaft inserted into the inner joint part, in coaxial alignment of the inner and outer joint parts;

FIG. 7B shows the counter track joint of FIG. 7A in an articulated condition in longitudinal section through a first pair of tracks;

FIG. 7C shows the counter track joint of FIG. 7A in an articulated condition in longitudinal section through a second pair of tracks;

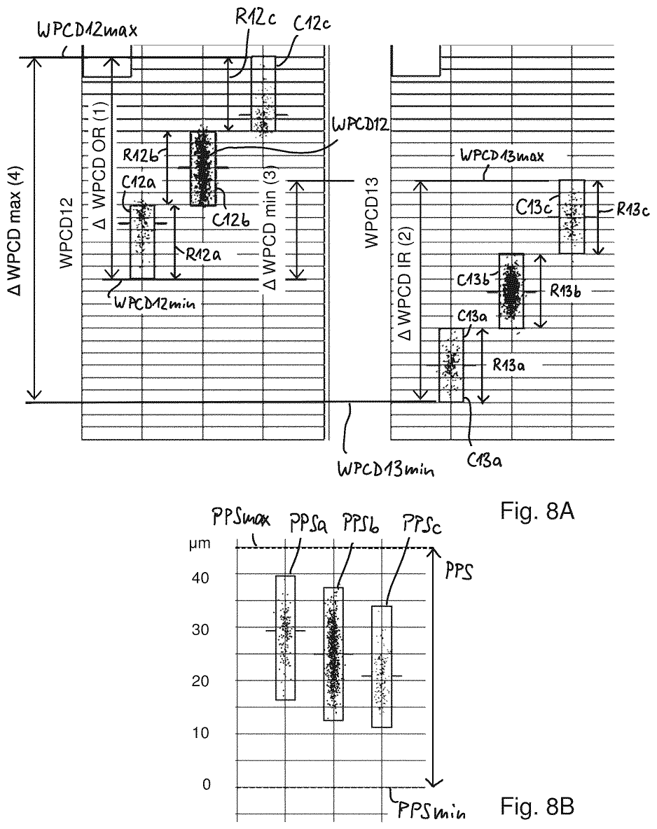

FIG. 8A shows a graphical representation of measurement results of batches of first and second joint parts assigned to a respective one of three tolerance groups; and

FIG. 8B shows a graphical representation of the pitch path separations PPS of pairs of a first inner and outer ball track and pairs of a second inner and outer ball track of inner and outer joint parts, which are assigned to each other according to their tolerance groups shown in FIG. 8A.

A method according to the invention for producing a counter track joint 11 is described with reference to FIGS. 1A to 8B. The method for producing a counter track joint comprises: producing a first joint part 12, producing a second joint part 13, producing a ball cage 15, producing balls 14A, 14B, inserting the inner joint part into the ball cage 15, inserting the ball cage 15 into the outer joint part and inserting the balls 14A, 14B into the cage windows 18, with the first pairs of tracks and second pairs of tracks each receiving one of the balls 14A, 14B.

FIGS. 1A to 1E, jointly also referred to as FIG. 1, show a first joint part 12 for a constant velocity joint produced according to the invention. The first joint part 12 is produced with first ball tracks 22A and second ball tracks 22B which are circumferentially distributed in a circumferential surface 24 of the first joint part 12. The first joint part 12 comprises a first longitudinal axis L12. The first ball tracks 22A respectively have a first curvature in a longitudinal section including a central curvature portion widening towards an opening side 20′ of the first joint part 12 and a first maximum curvature portion having a greatest radial distance from the first longitudinal axis L12. The second ball tracks 22B respectively have a second curvature in a longitudinal section with a central curvature portion widening towards an attachment side 19′ of the first joint part 12 and a second maximum curvature portion having a greatest radial distance from the longitudinal axis L12. The first and second ball tracks 22A, 22B of the first joint part 12 are soft-finished and hardened, i.e. remain unmachined after hardening.

After hardening, a first working PCD is determined based on the first curvature A of the first ball tracks 22A and the second curvature B of the second ball tracks 226 of the first joint part 12. The value determined for the first working PCD, which is referred to as WPCD12, is within a first overall working PCD tolerance range which is referred to as ΔWPCD12. The working PCD of the first joint part 12 can be determined so as to be representative for the first and the second ball tracks 22A, 22B. For example, the first WPCD can be determined to be the smallest intersection of the first PCD, respectively first curvature A, of the first ball tracks 22A and the second PCD, respectively second curvature B, of the second ball tracks 226 of the first joint part 12. In particular, the first WPCD12 of the first joint part 12 can be determined in a system plane ES, where a WPCD of a first ball track 22A (WPCDA) and a WPCD of a second ball track 23B (WPCDB) are equal in size. The system plane ES can be arranged somewhere axially between an offset plane EA of the first ball tracks 22A and an offset plane EB of the second ball tracks 22B. The opening sided offset plane EA can be defined as the plane that includes the maximum curvature portions of the first ball tracks 22A 1o having the greatest radial distance from the axis L12. The attachment sided offset plane EB can be defined as the plane including the maximum curvature portions of the second ball tracks 22B having the greatest radial distance from the axis L12.

The second joint part 13 is produced with first ball tracks 23A and second ball tracks 23B which are circumferentially distributed in a circumferential surface 26 of the second joint part 13. The second joint part 13 defines a second longitudinal axis L13. The first ball tracks 23A of the second joint part 13 respectively have a first curvature A′ in a longitudinal section including a central curvature portion widening towards an opening side 20′ of the second joint part and a first maximum curvature portion having a greatest radial distance from the second longitudinal axis L13. The second ball tracks 23B of the second joint part 13 respectively have a second curvature B′ in a longitudinal section including a central curvature portion widening towards an opposite side 19′ of the second joint part 13 and a second maximum curvature portion having a greatest radial distance from the second longitudinal axis L13. The first and second ball tracks 23A, 236 of the second joint part 13 are soft-worked, hardened, and preferably hard-machined after hardening.

Hard-machining of the first and the second ball tracks 22A, 22B of the second joint part 13 can be carried out such that a second working PCD value WPCD13 is within a second overall working PCD tolerance range ΔWPCD13. The working PCD of the second joint part 13 can be determined so as to be representative for the first and the second ball tracks 23A, 23B, in particular based on a first track line A′ of a first ball tracks 23A and a second track line B′ of a second ball track 23B. For example, the second WPCD may be determined to be the smallest enveloping circle or roundness around one or more of the WPCD, respectively track lines A′ of the first ball tracks 23A and one or more of the WPCD, respectively track lines B′ of the second ball tracks 23B of the second joint part 13.

FIGS. 5A and 5B show an outer joint part 12 and an inner joint part 13, with the determined working PCDs drawn in. An inner joint part 13 with a WPCD1 3 determined on the basis of the working PCD of the first track line A′ and second track line B′ can be graded and matched with a respective outer joint part 12 with a WPCD12 determined on the basis of the working PCD of the first track line A and second track line B.

On the left hand side of FIG. 5C, exemplary values and dimensions are shown for a batch of outer joint parts 12 produced as described above. One can see a first tolerance range ΔWPCD12 of the outer joint part. The first tolerance range ΔWPCD12 is defined to be the difference between the maximum working PCD and the minimum working PCD of the outer joint part 12, i.e.

$$Δ WPCD 12 = WPCD 12 max - WPCD 12 min \qquad ( 1 )$$

The first WPCD value determined from the first ball tracks 22A of the outer joint part 12 lays within the first tolerance range ΔWPCD12. The first tolerance range ΔWPCD12 can be, for example, between 30 and 300 micrometers, in particular between 60 and 150 micrometers. In the present example, the first tolerance range ΔWPCD12 comprises two different size classes C12a, C12b, wherein it is understood that a higher number of size classes can be selected as well, for example 3, 4, 5 or more. Depending on the determined first WPCD, the first joint part 12 is classified into one of said different size classes C12a, C12b. For example, the first joint part 12 can be assigned to the first size class C12a when the first WPCD value is within a first predetermined PCD range R12a, or to a second size class C12b when the first WPCD value is within a second predetermined PCD range R12b. The second size class C12b adjoins the first size class C12a and comprises WPCD values that are greater than the first size class C12a. The extension of the ranges R12a, R12b depends on the number of size classes C12a, C12b. In the present example with a number of two size classes C12a, C12b, the first and second PCD ranges R12a, R12b can be for example between 15 and 150 micrometers, in particular between 30 and 75 micrometers.

On the right hand side of FIG. 50, exemplary values and dimensions are shown for a batch of inner joint parts 13 produced as described above. One can see a tolerance range ΔWPCD13 of the inner joint part 13. The tolerance range ΔWPCD13 is defined to be the difference between the maximum working PCD and the minimum working PCD of the inner joint part 13, i.e.

$$Δ WPCD 13 = WPCD 13 max - WPCD 13 min \qquad ( 2 )$$

Furthermore, the minimum overall tolerance range ΔWPCDmin is defined to be the difference between the minimum working PCD of the outer joint part 12 and the maximum working PCD of the inner joint part 13, i.e.

$$Δ WPCD min = WPCD 12 min - WPCD 13 max \qquad ( 3 )$$

It can be seen in FIG. 5C that the working PCD of the other joint part 12 (WPCD12) and the working PCD of the inner joint part 13 (WPCD13) overlap each other by ΔWPCDmin. The scale for WPCD12 and WPCD13 shown in FIGS. 5A and 5B can be in steps of 5 micrometers, for example. A joint PCD value of a mounted counter track joint for a sideshaft of a motor vehicle can be, for example, between 55 and 65 mm, without being limited thereto.

The maximum overall tolerance range ΔWPCDmax is defined to be the difference between the maximum working PCD of the outer joint part 12 and the minimum working PCD of the inner joint part 13, i.e.

$$Δ WPCD max = WPCD 12 max - WPCD 13 min \qquad ( 4 )$$

A WPCD value determined from the outer joint part 13 (WPCD13) lays within the first tolerance range ΔWPCD13. The first tolerance range ΔWPCD13 can be, for example, between 40 and 300 micrometers, in particular between 60 and 150 micrometers. In the present example, the first tolerance range ΔWPCD13 comprises two different size classes C13a, C13b, as well. It is understood however that a higher number of size classes can be selected as well, for example 3, 4, 5, 6, 7 or more, and that the number of size classes C13 for the outer joint part 13 can be greater than the number of size classes C12 for the inner joint part 12. However, in a specific embodiment where the second joint part 13 is hard-machined after hardening, due to a high production accuracy, one can also do without any classification to a size class. In this case, the second joint part could be produced such that the second WPCD value is within the required tolerances matching the first WPCD value of the first joint part straight away.

To match the determined WPCD of the first joint part 12, the second joint part 13 can be produced accordingly and/or classified to one of said different size classes C13a, C13b. For example, the second joint part 13 can be assigned to a first size class C13a when the first WPCD value is within a first predetermined PCD range R13a, or to a second size class C13b when the first WPCD value is within a second predetermined PCD range R13b. The size of the ranges R13a, R13b depends on the number of size classes C13a, C13b. In the present example with a number of two size classes C13a, C13b, the first and second PCD ranges R13a, R13b can be for example between 20 and 150 micrometers, in particular between 30 and 75 micrometers.

A second joint part 13 is assigned to a first joint part 12, depending on the size class C12a, C12b of the first joint part 12, such that the difference between the WPCD12 of the first joint part 12 and the second working POD value WPCD13 of the second joint part 13 is greater than 20 and smaller than 80 micrometers. Each one of the first size classes C12a, C12b provided for classifying the first joint part 12 covers a first PCD value range R12a, R12b of preferably at least 10 and at most 45 micrometers. The second joint part 13 can be selected such that the measured PCD13 deviates by 5 to 50 micrometers from an edge value of the first PCD value range R12a, R12b of a mating first size class C12a, C12b of the first joint part 12.

The PCD value range R12a, R12b of the first joint part 12 and the respective PCD value range R13a, R13b of the second joint part 13 are selected such that there is always a gap between the maximum of the value range R13a, R13b of the inner joint part 13 and the minimum of the respective value range R12a, R12b of the outer joint part 12. Thus, the WPCD of the inner joint part is smaller than the WPCD of the outer joint part so that a pitch path separation PPS is obtained. In a mounted condition of the constant velocity joint 2, the pitch path separation PPS represents half of the difference between the WPCD12 of the first joint part 12 and the WPCD13 of the second joint part, i.e. PPS=(WPCD12−WPCD13)/2.

FIG. 5D shows the pitch path separation range PPSa which results from pairing inner joint parts 13 whose WPCD are within the value ranges R13a with outer joint parts 12 whose WPCD are within the value ranges R12a. Accordingly, the pitch path separation range PPSb results from pairing inner joint parts 13 of value ranges RI 3b with outer joint parts 12 of value ranges R12b. The overall pitch path separation range PPS can be given as the difference between the maximum PPS value PPSmax and the minimum PPS value PPSmin. The PPS can be for example between 5 and 45 micrometers, without being limited thereto.

A ball cage 15 which is shown as a detail in FIGS. 3A to 3C is provided with a cage axis L15, an inner cage surface 17, an outer cage surface 16, and cage windows 18 circumferentially distributed about the cage axis L15. The outer and inner cage surface 16, 17 are produced so as to have axial and radial play relative to the respective circumferential surface 24, 26 of the first joint part 12 and second joint part 13. In the embodiment shown here, the first joint part 12 is an outer joint part and the second joint parts 13 is an inner joint part. In the present embodiment, the surface centers M16 and M17 lie in a common joint center plane EM, wherein in a modified embodiment the surface centers M16 and M17 may also each have an axial offset with respect to the joint center plane EM in opposite directions.

An exemplary ball 14A, 146 is shown in FIG. 4. The balls are preferably produced with a production tolerance of less than four micrometers with respect to a nominal ball diameter. With such high production accuracy, any ball 14A, 14B can be used for any of the pairs of first ball tracks 22A, 23A and second ball tracks 226, 236.

The counter track joint 2 produced with the method according to the invention is shown in FIGS. 6A to 6D in a mounted condition.

In the mounted condition, a circumferential clearance 25 is formed between the outer surface 16 of the ball cage 15 and the inner surface 24 of the outer joint part 12. A circumferential clearance 27 is also formed between the inner surface 17 of the ball cage 15 and the outer surface 26 of the inner joint part 13. The first joint part 12, second joint part 13 and cage 15 are produced such that in a mounted and aligned condition of the counter track joint, a first axial play So between the ball cage 15 and the first joint part 12 and a second axial play Si between the ball cage 15 and the second joint part 13 are different in size. The first axial play So is the sum of an opening sided axial play Soa and a base sided axial play Sob between the cage outer surface 16 and the inner surface 24 of the outer joint part. The second axial play Si is the sum of an opening sided axial play Sia and a base sided axial play Sib between the cage inner surface 17 and the outer surface 27 of the inner joint part 13.

The balls 14A, 14B are held in circumferentially distributed cage windows 18 in the ball cage 15 in the joint center plane EM. A longitudinal axis L12 is marked on the outer part 12 of the joint, and a longitudinal axis L13 is marked on the inner part 13 of the joint. The point of intersection of the longitudinal axes L12, L13 with the joint center plane EM forms the joint center point M.

In the present embodiment, the inner surface 24 of the outer joint part 12, the outer cage surface 16, the inner cage surface 17 and the outer surface 27 of the inner joint part 13 have a spherical form. Alternatively or additionally, one or more of said surfaces may have cylindrical, toroidal and/or conical sections. With respect to the inner surface 24 of the outer part 12, an opening-side section 24a, a central section 24c and a bottom-side section 24b are shown in FIG. 1C. The bottom-side section 24b forms a support surface against which the ball cage 15 can be axially supported by its outer surface 16.

The outer joint part 12 has a base 19, which can comprise a connecting journal, for example, and an opening 20. The inner joint part 13 has an opening 34, into which the journal of a drive shaft 30 can be inserted in a rotationally fixed manner for transmitting torque. A counter track joint 11 with mounted shaft 30 is shown in FIGS. 7A to 7C. In the present disclosure, the position of the base 19 denotes the axial direction “towards the attachment side”, and the position of the opening 20 denotes the axial direction “towards the opening side”. These terms are also used with reference to the inner part of the joint as 19′ and 20′, disregarding the actual connection of a shaft to the inner part of the joint 13.

The first pairs of tracks 22A, 23A with torque transmitting first balls 14A and the second pairs of tracks 22B, 23B with torque transmitting second balls 14B alternate over the circumference. The shape of the first pairs of tracks 22A, 23A is shown in FIG. 7B, and the shape of the second pairs of tracks 22B, 22B is shown in FIG. 7C. The first balls 14A are in contact with first outer ball tracks 22A in the outer joint part and first inner ball tracks 23A in the inner joint part. Here, the centers of the first balls 14A define a first center line A, A′ when moving along the outer and inner first ball tracks 22A, 23A, respectively, while the centers of the second balls 14B define a second center line B, B′ when moving along the outer and inner second ball tracks 22B, 23B, respectively.

With the outer joint part 12 and inner joint part 13 aligned coaxially, the tangents T22A, T23A to the balls 14A in the contact points with the first tracks 22A, 23A form an opening angle δA that opens toward the opening side. The second balls 14B are guided in outer ball tracks 22B in the outer joint part 12 and inner ball tracks 23B in the inner joint part 13. The balls 14A, 14B are shown with contact in the track base of the ball tracks, which is optional. The balls can also be in two point contact in a cross sectional view and, in this case, can have a radial clearance to the respective track base. In the aligned condition shown, the tangents T22B, T23B to the second balls 14B in the contact points with the second tracks 22B, 23B form a second opening angle δB opening towards the connection side. In a modified track form of the counter track joint, the opening angles oriented in opposite axial directions can also result in a slightly angled position of the joint of, in particular, up to 2°.

The first and second pairs of tracks each lie with their centerlines in a radial plane through the joint, without being limited thereto. A respective ball 14A, 14B is received in a cage window 13 in the ball cage 15. The radial planes each have the same angular distance from each other. The number of torque-transmitting balls 14A, 14B and correspondingly the number of outer and inner ball tracks is eight in the present case, without being restricted thereto. In each case, two first pairs of tracks 22A, 23A of the outer joint part 12 and inner joint part 13 are diametrically opposite each other, and two second pairs of tracks 22B, 23B are diametrically opposite each other.

In the present disclosure, the following definitions apply for a counter track joint:

The joint articulation angle β defines the angle included between the longitudinal axis L12 of the outer joint part 12 and the longitudinal axis L13 of the inner joint part 13. The joint articulation angle β is zero when the joint is aligned.

The opening angle δ defines the angle enclosed by tangents T to the balls at the points of contact with the first ball tracks and the second ball tracks, respectively, when the joint is in the aligned condition.

The center plane EM is defined by the ball centers of the torque transmitting balls 14A, 14B when the joint is aligned.

The first pitch circle diameter PCDA defines the diameter formed by the centers of the first balls 14A when the joint is aligned.

The second pitch circle diameter PCDB defines the diameter formed by the centers of the second balls 14B when the joint is aligned.

FIGS. 8A and 8B show another embodiment for classifying and matching the WPCD values of the first and second joint parts 12, 13. The present example widely corresponds to the embodiment shown in FIGS. 5A and 5B, to which it is hereby referred with regard to corresponding features, with the same and/or corresponding details having the same reference signs as in FIGS. 5A and 5B. The first joint part 12 and the second joint part 13 can be produced as described above, with one of the first and second joint parts (12, 13) being soft-finished and the other one of the first and second joint parts (13, 12) being hard-finished.

In the present embodiment, the first tolerance range ΔWPCD12 comprises three different size classes C12a, C12b, C12c. Depending on the determined first WPCD, the first joint part 12 is classified into one of said different size classes C12a, C12b, C12c.

For example, the first joint part 12 can be assigned to a first size class C12a when the first WPCD value is within a first predetermined PCD range R12a, to a second size class C12b when the first WPCD value is within a second predetermined PCD range R12b, and to a third size class C12c when the first WPCD value is within a third predetermined PCD range R12c. The size of the ranges R12a, R12b, R12c depends on the number of size classes C12a, C12b, C12c. In the present example with a number of three size classes C12a, C12b, C12c, the first and second PCD ranges R12a, R12b, R12c can respectively be, for example, between 10 and 100 micrometers in particular between 20 and 50 micrometers.

On the right hand side of FIG. 8A, exemplary values and dimensions are shown for a batch of inner joint parts 13 produced as described above. The first WPCD value determined from the inner joint part 13 lays within the tolerance range ΔWPCD13. The first tolerance range ΔWPCD13 can be, for example, between 40 and 300 micrometers, in particular between 60 and 150 micrometers. In the present example, the tolerance range ΔWPCD13 comprises three different size classes C13a, C13b, C13c as well, without being limited thereto.

To match the determined WPCD of the first joint part 12, the second joint part 13 can be produced accordingly and/or classified to one of the size classes C13a, C13b, C13c. For example, the second joint part 13 can be assigned to a first size class C13a when the first WPCD value is within a first predetermined PCD range R13a, or to a second size class C13b when the first WPCD value is within a second predetermined PCD range R13b, or to a third size class C13c when the first WPCD value is within a third predetermined PCD range R13c. The size of the ranges R13a, R13b, R13c depends on the number of size classes C13a, C13b, C13c. In the present example with a number of three size classes C13a, C13b, C13c, the first and second PCD ranges R13a, R13b, R13c can be for example between 10 and 100 micrometers, in particular between and 50 micrometers, without being limited thereto.

In a mounted condition of the constant velocity joint, the pitch path separation PPS represents a radial play of the balls in the respective pairs of tracks. FIG. 8B shows the pitch path separation range PPSa which results from pairing inner joint parts 13 of value ranges R13a with outer joint parts 12 of value ranges R12a. Accordingly, the pitch path separation range PPSb results from pairing inner joint parts 13 of value ranges R13b with outer joint parts 12 of value ranges R12b, and the pitch path separation range PPSc results from pairing inner joint parts 13 of value ranges R13c with outer joint parts 12 of value ranges R12c. The PPS can be for example between 5 and 45 micrometers, without being limited thereto.

### LIST OF REFERENCE SIGNS

11 counter track joint
12 first/outer joint part
13 second/inner joint part
14A, 14B ball
15 cage
16 outer face (15)
17 inner face (15)
18 window
19 attachment side/base
20 opening side/opening
22A, 22B first, second outer ball track
23A, 23B first, second inner ball track
24 inner face (12)
25 outer clearance
26 outer face (13)
27 inner clearance
28 radial extension
29 pocket
30 shaft
31 web
32 flattening
33 web
34 opening
A, A′ track line
B, B′ track line
C size class
L longitudinal axis
M joint center
T tangent
EA first offset plane
EB second offset plane
EM joint center plane
ES system plane
Si inner overall axial play
So outer overall axial play
PCD pitch circle diameter
PPS pitch path separation
R size range
WPCD working pitch circle diameter
β articulation angle
δ opening angle
ΔWPCD tolerance range

1. A method for producing a counter track joint,
producing a first joint part with first ball tracks and second ball tracks which are circumferentially distributed in a circumferential surface of the first joint part, with the first joint part having a first longitudinal axis,
wherein the first ball tracks respectively have a first curvature in a longitudinal section with a central curvature portion widening towards an opening side of the first joint part,
wherein the second ball tracks respectively have a second curvature in a longitudinal section with a central curvature portion widening towards an attachment side of the first joint part,
wherein the first ball tracks and second ball tracks of the first joint part are soft-finished and hardened, i.e. remain unmachined after hardening;
determining a first working PCD value of the first joint part;
classifying the first joint part to a size class of at least two different size classes depending on the first working PCD value,
producing a second joint part with first ball tracks and second ball tracks which are circumferentially distributed in a circumferential surface of the second joint part, with the second joint part having a second longitudinal axis,
wherein the first ball tracks of the second joint part respectively have a first curvature in a longitudinal section with a central curvature portion widening towards an opening side of the second joint part,
wherein the second ball tracks of the second joint part respectively have a second curvature in a longitudinal section with a central curvature portion widening towards an opposite side of the second joint part,
wherein the first ball tracks and second ball tracks of the second joint part are soft-worked and hardened;
wherein the first ball tracks of the second joint part respectively have a first curvature in a longitudinal section with a central curvature portion widening towards an opening side of the second joint part,
wherein the second ball tracks of the second joint part respectively have a second curvature in a longitudinal section with a central curvature portion widening towards an opposite side of the second joint part,
wherein the first ball tracks and second ball tracks of the second joint part are soft-worked and hardened;
assigning the second joint part, depending on the second working PCD value, to a mating one of the size classes of the first joint part, such that a difference between the first working PCD value of the first joint part and the second working PCD value of the second joint part is greater than 20 and smaller than 80 micrometers;
producing a ball cage having a cage axis, an inner cage surface, an outer cage surface, and cage windows circumferentially distributed about the cage axis, wherein the inner cage surface and outer cage surface are produced so as to have axial and radial play relative to the respective circumferential surface of the first joint part and second joint part, with one of the first and second joint parts being an outer joint part and the other one of the first and second joint parts being an inner joint part;
producing balls;
inserting the inner joint part into the ball cage;
inserting the ball cage into the outer joint part; and
inserting the balls into the cage windows, with the first pairs of tracks and second pairs of tracks each receiving one of the balls;
wherein in an assembled and aligned condition of the counter track joint, a first axial play between the ball cage and the first joint part and a second axial play between the ball cage and the second joint part are different in size.

2. The method according to claim 1,
wherein the first ball tracks and the second ball tracks of the second joint part are hard-machined after hardening,
wherein after having been hard-machined, the first working PCD value is determined taking into account the first curvature of the first ball tracks and the second curvature of the second ball tracks of the first joint part, wherein the first working PCD value is within a first overall working PCD tolerance range.

3. The method according to claim 2,
wherein the first ball tracks and second ball tracks of the first joint part are finish-forged before hardening, and
wherein the first ball tracks and second ball tracks of the second joint part are mechanically finish-machined after hardening.

4. The method according to claim 1,
wherein the balls are produced with a production tolerance of less than four micrometers with respect to a nominal ball diameter.

5. The method according to claim 1,
wherein each one of the at least two first size classes defined for classifying the first joint part covers a PCD value range of at least 10 and at most 45 micrometers.

6. The method according to claim 5,
wherein the second joint part is selected such that the second working PCD value deviates by 5 to 50 micrometers from an edge value of a mating one of the first PCD value ranges of the first joint part.

7. The method according to claim 1,
wherein the first working PCD of the first joint part is determined as a function of the first curvatures of the first ball tracks and the second curvatures of the second ball tracks of the first joint part, and
wherein the second working PCD of the second joint part is determined as a function of the first curvatures of the first ball tracks and the second curvatures of the second ball tracks of the second joint part.

8. The method according to claim 1,
wherein the first working PCD of the first joint part is determined in a system plane, wherein a working PCD of a track line of the first ball track and a working PCD of a track line of the second ball track are equal in size.

9. The method according to claim 1,
wherein the first joint part is assigned to a first size class when the first working PCD value is within a first predetermined PCD range, or to a second size class when the first working PCD value is within a second predetermined PCD range, or to a third size class when the first working PCD value is within a third predetermined PCD range.

10. The method according to claim 1,
wherein the first joint part, the second joint part and the ball cage are produced such that, in the assembled and aligned condition of the counter track joint, the first axial play between the ball cage and the first joint part differs from the second axial play between the ball cage and the second joint part by more than 25 micrometers, wherein one of the first axial play and the second axial play is greater than 50 micrometers and the other one of first axial play and the second axial play is greater than 75 micrometers.

11. The method according to claim 1,
wherein the first joint part is produced in the form of an outer joint part, and the second joint part is produced in the form of an inner joint part,
wherein the first ball tracks, the second ball tracks and the circumferential surface of the outer joint part are soft-finished, and the first outer ball tracks and the second outer ball tracks of the outer joint part are then hardened, and,
wherein the first ball tracks, the second ball tracks and the circumferential surface of the inner joint part are soft pre-machined, then hardened, and then hard finish-machined.

12. The method according to claim 1,
wherein the first outer ball tracks are formed so as to have a first outer undercut on the opening side, and the second outer ball tracks are formed so as to have a second outer undercut on the opening side, wherein the first outer undercut is smaller than the second outer undercut.

13. The method according to claim 1,
wherein at least one of the outer cage surface and the inner cage surface is soft-finished, and then hardened.

14. The method according to claim 1,
wherein the outer joint part and the inner joint part are produced such that, in the operational condition of the counter track joint, the inner joint part is angularly movable relative to the outer joint part by an articulation angle of more than 200 and not more than 30°; and
wherein the ratio of the working PCD of the outer joint part to the largest diameter of an insertion opening of the inner joint part is smaller than 2.05.

15. The method according to claim 1,
wherein, for mounting the balls, the inner joint part is rotated relative to the outer joint part such that the first inner ball tracks are opposite the first outer ball tracks and form first pairs of tracks which widen towards the opening side of the outer joint part, and the second inner ball tracks are opposite the second outer ball tracks and form second pairs of tracks which widen towards the connecting side of the outer joint part;
inserting balls into said cage windows with said inner joint part and said outer joint part deflected relative to each other, with said first pairs of tracks and said second pairs of tracks each receiving one of the balls, the balls being held by the ball cage on a joint center plane with the longitudinal axes of the inner joint part and the outer joint part aligned coaxially;
wherein at least one of a partial number of webs of the inner joint part are produced with flattenings on both sides, so that threading into a cage window of the ball cage for assembly is possible, or,
at least partial number of the second outer ball tracks of the outer joint part is produced on the connecting side with a pocket which is radially recessed with respect to a functional track portion and into which an associated ball can move radially when the constant velocity joint is deflected.
